(19) United States
(12) Patent Application Publication
(10) Pub. No.: US 2007/0086792 A1
(43) Pub. Date: Apr. 19, 2007

(54) Data receiver with positive feedback

(76) Inventor: Zvi Regev, Chatsworth, CA (US)

Correspondence Address: BERGMAN & SONG, LLP, P.O. BOX 400198, CAMBRIDGE, MA, 02140, US

(21) Appl. No.: 11/512,602

(22) Filed: Aug. 29, 2006

Related U.S. Application Data
(60) Provisional application No. 60/712,337, filed on Aug. 29, 2005.

(51) Int. Cl. H04B 10/06

(52) U.S. Cl. 398/209

(57) ABSTRACT

A data communication device adapted to receive a data stream includes positive feedback. The positive feedback allows the data communication device to operate with a bi-stable operating characteristic. Consequently the data communication device exhibits superior rejection of signal input noise and reduced chatter. According to various embodiments, the data communication device includes a plurality of component devices having dc coupling therebetween.

### CROSS REFERENCE TO RELATED APPLICATION

This application claims the benefit under 35 U.S.C. § 119(e) of U.S. Provisional Application No. 60/712,337 filed Aug. 29, 2005, entitled Method and Circuit for Handling Bursts of Data Streams, the contents of which is hereby incorporated by reference in its entirety.

### FIELD OF THE INVENTION

The present invention relates to data communication systems and methods and, more particularly, to intermittent data communication systems and methods.

### BACKGROUND OF THE INVENTION

Data communication systems and methods are used in the transmission of information for an increasing variety of purposes, including the control of equipment. As such, improving the performance of data communication systems has become an important focus of attention. For example, optical communication systems are continually undergoing improvement in many areas related to performance such as capacity, bandwidth, and instantaneous data transmission rate.

Certain communication networks require that signals be transmitted continuously, in order to ensure that clock and data recovery devices (e.g., including phase locked loop (PLL) devices) at the receiver are always synchronized and locked to receive the transmitted data. In such networks, if no payload data is awaiting transmission, a special “idle” signal is transmitted. The idle signal maintains the clock and data recovery devices in a synchronized and locked state.

Other data communication systems and methods involve the use of signals that include “burst mode” data. In burst mode data communication, one or more data packets are transmitted substantially continuously over a signal channel during a data transmission time interval. During another quiescent time interval, the signal channel is substantially free of signals. Accordingly, in some data transmission schemes a plurality of quiescent time intervals are disposed chronologically between a corresponding plurality of data transmission time intervals. The combination of the data transmission time intervals and the quiescent time intervals is known as a “datastream.” The quiescent time intervals are referred to as “gaps” in the datastream.

Data streams including data bursts and gaps are found in well-known communication protocols including RS-422, RS-485, IEEE 1394, and other data communication protocols. Under these protocols, a plurality of data packets are lumped together and transmitted as a burst of data after which a data gap is present on the transmission media.

The communication of burst mode data poses special problems in the configuration of data communication hardware. Digital data is communicated over a wide variety of media and hardware systems. For transmission over any extended distance, and within switching and routing equipment, differential signals are typically used. Unlike single ended signals, which are communicated over a single conductor and reference the ground, differential signals are communicated in complementary voltages (as viewed with respect to ground) over two conductors, each being referenced to the other. Typical communication media includes coaxial cable, twisted pair copper wire, single mode and multimode optical fiber, and terrestrial and satellite linked free air transmission, among others.

It is characteristic of most data transmission systems that they employ a variety of amplifiers, repeaters, switching and routing equipment. Many communication systems have been built up over time, with the addition of components as demand has expanded. As a practical matter a particular communication link may employ various components having a variety of ages and including a number of different technologies. Consequently, for example, different modules of a communication network may employ respective logic families with corresponding logic level definitions that are not intrinsically compatible with one another. In order to allow interoperability between different existing modules, and to allow for the development of future technologies, signals into and out of data routers and similar switching devices are typically connected using an AC coupling scheme such as, for example, capacitive coupling. Capacitive coupling permits the detection of digital data transitions between modules while excluding DC voltage levels that may be incompatible between modules.

It is customary to use pluggable media interface devices in the form of copper line and fiber optic transceivers, which are AC coupled to the systems into which they are plugged. The pluggable interfaces include interface elements known in the art as SFP, SFF, and SFX pluggable interfaces, among others. The pluggable line interface units are typically AC coupled to avoid having to define which logic family is to be used both on the pluggable unit and on the data switching equipment. Since there are more than half a dozen logic families in use both in the pluggable units and on the data switching systems, using AC coupling is an easy way to get around the compatibility issue.

As is widely understood, digital data consists of sequences of “ones” and “zeros” representing characters of the transmitted data. Since the sequence of the characters in the transmitted data is “random” for all practical purposes, so is the sequence of “1”s and “0”s representing these characters. As a result, in a typical data stream there can be a pattern containing any number of consecutive “1”s and “0”s. This creates a problem when AC coupling is used since an uneven number of “1”s and “0”s in any sequence length generates a changing DC component in the data stream. This changing DC component constitutes a low frequency AC signal. The low frequency AC signal is able to pass through the AC coupled interfaces and may cause errors in the transmitted data.

When data is transmitted continuously, both inputs of a differential receiver experience regular signal transitions. The signal transitions keep the inputs on respective opposite sides of a common bias voltage. The presence of signal transitions requires that differential inputs of a data receiver have the same potential only very briefly during data signal transitions from one logic state to the complementary state. When data is not transmitted continuously, there are “quiet” gaps between one data transmission and the next one. During such gaps the two inputs of the differential receiver experience no signal transitions. Under these conditions, as will be explained in additional detail below, there is a tendency for both inputs to settle at a common bias potential.

When both complementary inputs of a differential receiver are at the same potential, that receiver is at its highest sensitivity. Any noise on a transmission medium that is coupled to the receiver inputs may cause the output of the receiver to erroneously change state and create what is known in the art as “chatter”.

One conventional approach to reducing chatter is to lower a gain of the receiver. This lowers the receiver's sensitivity and requires a larger signal to cause a change at the output of the receiver.

In another approach to dealing with data patterns having an intrinsic DC component, data is encoded prior to transmission, in a special “DC free” code. The data transmitted is typically encoded in such that, over any given time interval, the sum of time periods at which the data is in the state of “1” equals the sum of the time periods at which the data is in the “0” state. Such encoding is referred to as DC balanced encoding, and is effective for the transmission of a continuous datastream through an AC coupled interface. DC balanced encoding is less effective for burst mode data transmission, however, because the quiescent single that is present during a data gap tends to average to a lower signal value than the DC balanced signal that is present during a data burst.

### SUMMARY

In view of the foregoing the inventor has concluded that there is a need for an improved device capable of communicating digital data such as, for example, burst mode data while minimizing signal chatter. The inventor has recognized that it is advantageous to have a device adapted to maintain respective input nodes of an input in an electronically biased state such that the respective electrical potentials of those nodes do not drift toward a common voltage during time intervals when incoming signals are substantially quiescent. Specifically, according to one embodiment of the invention, the input nodes of a differential input are, for example, forced to different respective electrical potentials. Consequently, a threshold voltage is established that serves to minimize chatter that might otherwise occur in response to transmission noise. A differential voltage across the differential input that is less than the threshold voltage is rejected by the receiver input. On the other hand, a received legitimate signal having a differential voltage larger than the threshold voltage causes an output of the device to toggle responsively.

Having made these discoveries and conclusions, the inventor has further invented a signal receiving device and method including positive feedback that is adapted to maintain an electrical potential difference between input nodes, such as differential input nodes, of a receiving device. According to one embodiment of the invention a differential potential is maintained between input nodes by coupling differential outputs of a device to respective differential inputs of the same device. The resulting positive feedback causes a device to enter a saturated state. Various embodiments of the invention are described herewithin including a receiving device exhibiting a bi-stable, or flip-flop, input characteristic. Among these various embodiments, is a device having an RS flip-flop characteristic.

According to one embodiment of the invention, a data switch device includes a plurality of receiving devices DC coupled to a data handling device such as a crossbar switch which is, in turn, DC coupled to a plurality of data driving devices. One of ordinary skill in the art will appreciate that every AC coupled differential interface offers the potential to introduce chatter into the system. Accordingly, in one embodiment of the invention, DC signal coupling is used downstream of a bi-stable AC coupled differential input. In this way the differential outputs of such an embodiment are maintained in complementary logic states during any data gap time interval.

This DC coupling method is distinguishable from the arrangement found in some digital data communication systems where, as discussed above, AC coupled pluggable interfaces are used. Since there are more than half a dozen logic families in use both in the pluggable units and on the data switching systems, using AC coupling is an easy way to get around the compatibility issue. Pluggable line interface units capable of being DC coupled to a majority of (or all) data switching equipment require special interface circuit designed to be compatible with at least a known number of different logic families.

With the foregoing in mind, the specification describes a variety of embodiment of the invention including a data receiver having a positive feedback device, a data receiver having an RS flip-flop characteristic and a data receiver with improved noise immunity adapted to be DC coupled to a downstream data handling device.

These and other advantages and features of the invention will be more readily understood in relation to the following detailed description of the invention, which is provided in conjunction with the accompanying drawings.

### BRIEF DESCRIPTION OF THE DRAWINGS

FIG. 1 shows, in block diagram form, a substantially conventional data switch device as prepared by the inventor;

FIG. 2 shows, in electrical schematic diagram form, a substantially conventional receiver device as prepared by the inventor;

FIG. 3 shows, in electrical schematic diagram form, a set-reset flip-flop device including two inverter devices, as prepared by the inventor;

FIG. 4 shows a state table indicating logical response of a set-reset flip-flop;

FIG. 5 shows, in electrical schematic diagram form, a receiving device according to one embodiment of the invention;

FIG. 6 shows, in electrical schematic diagram form, a receiving device according to another embodiment of the invention;

FIG. 7 shows, in electrical schematic diagram form, a receiving device according to still another embodiment of the invention;

FIG. 8 shows, in block diagram form, a data switch device according to one embodiment of the invention; and

FIG. 9 shows, in state diagram form, an operation of a receiving device according to one embodiment of the invention.

### DETAILED DESCRIPTION

The present invention relates to a data receiver for receiving intermittent, or burst mode, data transmissions. According to one embodiment, the invention includes a receiving device having positive feedback. In at least one embodiment, the receiving device exhibits a set reset flip-flop input characteristic. In various embodiments, a receiving device according to the invention includes DC coupling between an upstream component and a downstream component.

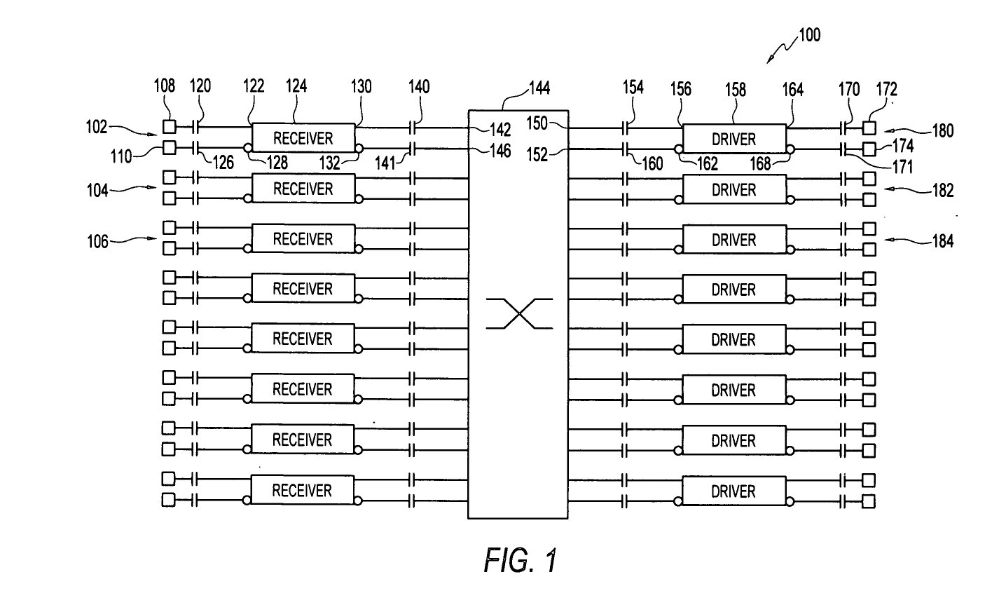

FIG. 1 shows a substantially conventional data switching device 100 as drawn by the inventor. As shown in FIG. 1, data switching device 100 includes a plurality of input ports 102, 104, 106 adapted to be coupled to a respective plurality of data signal lines. In the illustrated device, each of the input ports 102, 104, 106 is a differential input port. Accordingly, each differential input port is adapted to be coupled to a differential data signal line. Each input port, 102, 104, 106 includes a respective pair of input terminals e.g., 108, 110 where a first input terminal 108 of the pair is a noninverting input terminal and a second input terminal 110 of the pair is an inverting input terminal.

In order to isolate the data switching device 100 from low-frequency signals that may be present on the data signal lines, AC coupling is employed between the input ports 102, 104, 106 and the balance of the switching device 100. Accordingly, for example, a first capacitor 120 is electrically coupled in series between the noninverting input terminal 108 and a first noninverting input 122 of a first receiver device 124. A second capacitor 126 is electrically coupled in series between the inverting terminal 110 and a second inverting input 128 of the receiving device 124.

As illustrated, receiver device 124 also includes a noninverting output 130 and an inverting output 132. The noninverting output 130 of the receiver device 124 is electrically coupled in series through a further exemplary capacitor 140 to a first respective input 142 of a crossbar switch device 144. In like fashion, the inverting output 132 of the receiver device 124 is electrically coupled in series through a further exemplary capacitor 141 to a second respective input 146 of the crossbar switching device 144.

A crossbar switching device as exemplified by the illustrated crossbar switching device 144 includes a plurality of input ports and a corresponding plurality of output ports. The crossbar switching device is adapted to switchingly couple the input ports to the outputs under the control of received signals. One of skill in the art will appreciate that the illustrated system including receiving devices, driving devices and the crossbar switching device is one of many that might be employed in a data communication network and that might benefit from the advantages of the invention described herewith.

The crossbar switching device 144 includes outputs 150, 152. AC coupling is employed between the outputs 150, 152 of the crossbar switching device 144 and the balance of the switching device 100. Accordingly, a further exemplary capacitor 154 is electrically coupled in series between the output 150 and a first noninverting input 156 of a first driver device 158. A further exemplary capacitor 160 is electrically coupled in series between the output 152 and a second inverting input 162 of the driver device 158. In the illustrated device, the driver 158 also includes a noninverting output 164 and an inverting output 168.

As illustrated, the noninverting output 164 of the driver 158 is electrically coupled in series through a further exemplary capacitor 170 to a respective noninverting output terminal 172. In like fashion, the inverting output 168 of the driver 158 is electrically coupled in series through a further exemplary capacitor 171 to a respective inverting output terminal 174.

As shown in FIG. 1, the data switching device 100 includes a plurality of output ports 180, 182, 184, etc. adapted to be coupled to a respective plurality of data signal lines. In the illustrated device, each of the output ports 180, 182, 184 is a differential output port. Accordingly, each differential output port is adapted to be coupled to a differential data signal line.

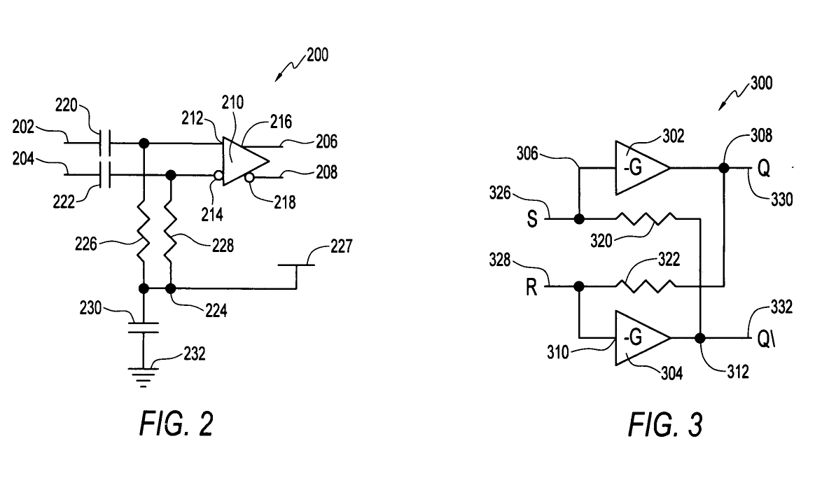

FIG. 2 shows an exemplary substantially conventional receiver device 200 as drawn by the inventor. As shown in FIG. 2 the device 200 includes a noninverting input node 202 and an inverting input node 204 along with a noninverting output 206 and an inverting output 208.

The receiver device 200 includes a differential amplifier 210. The differential amplifier 210 has a noninverting input 212 and an inverting input 214. The amplifier 210 also has a noninverting output 216 and an inverting output 218. A first capacitor 220 is electrically coupled in series between input 202 and noninverting input 212 of the differential amplifier 210. A second capacitor 222 is electrically coupled in series between the inverting input 204 and the inverting input 214 of the differential amplifier 210.

A node 224 is mutually coupled to a first resistor 226 and a second resistor 228. Node 224 is coupled through resistor 226 to noninverting input 212 and through resistor 228 to inverting input 214. Node 224 is also coupled to a source of reference potential 227 and through a third capacitor 230 to a source of ground potential 232.

In operation, the circuit 200 detects a signal transmitted via a differential signal line to the inputs 202, 204. The respective capacitors 220, 222 act to prevent direct current flow between the signal line and the inputs 212, 214. While receiving a continuous digital datastream, the inputs 212, 214 of the differential amplifier 210 are kept on opposite sides of a common reference voltage of source 227. The inputs 212, 214, assume the same potential only briefly during data signal transitions from one logic state to the complementary state. When no digital data signal is present at the inputs 202, 204 of the receiver device 200, however, inputs 212, 214 both tend to settle at the potential of source 227. When this occurs, the receiver is maximally sensitive, and is susceptible to noise on the transmission media. This can cause an erroneous change of state within the receiver device 200 and result in data corruption.

FIG. 3 shows an exemplary set-reset flip-flop device 300 as prepared by the inventor. As shown in FIG. 3, the device 300 includes a first inverting amplifier device 302 and a second inverting amplifier device 304. The first amplifier 302 has a first input 306 and a first output 308. The second amplifier device 304 has a second input 310 and a second output 312. The output 312 is coupled in series through a first resistor 320 to the input 306. The output 308 is coupled in series through a second resistor 322 to the input 310. Consequently, the circuit 300 embodies a set/reset flip-flop having as a first input (S) the input 326 and as a second input (R) the input 328, and also having as a first output (Q) the output 330 and as a second output (Q\) the output 332.

In operation, the device 300 exhibits, for example, an initial state in which input S 326 has a state of “logic one,” input R 328 has a state of “logic zero,” output Q 330 has a state of “logic zero” and output Q\332 has a state of “logic one.” The configuration of the device 300 is such that, in this state described, the output 312 of the amplifier 304 provides to the input 306 of the amplifier 302 an active voltage that serves to maintain input 326 of amplifier 302. In like fashion, the configuration of the device 300 is such that, in the state described, the output 308 of amplifier 302 provides to input 310 of the amplifier 304 an active voltage that serves to maintain a status quo input 328 of amplifier 304.

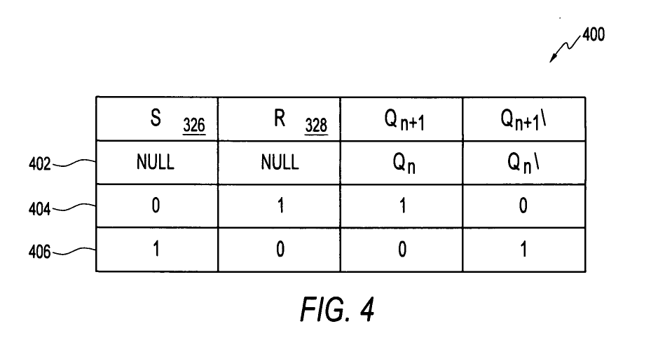

FIG. 4 shows a logic state table 400 for a set-reset flip-flop such as that of FIG. 3. Referring to line one, 402 of the state table 400, an input state of NULL at input 326 and an input state of NULL at input 328 representing the case when there is no signal present at the inputs, as during a data gap, yields next output states Qₙ₊₁ and Qₙ₊₁\ that are identical to current output states Qn and Qn\. Referring to line two 404 of state table 400, one of skill in the art will appreciate that an input state of 1 applies at input node 326 and an input state of 0 at input node 328 yields an output of 0 at node Q and an output of 1 at node Q. In like fashion, referring to line three 406 of the state table 400, an input state of 0 at input node 326 and an input state of 1 at input node 328 yields an output of 1 at node Q and an output of 0 at node Q\.

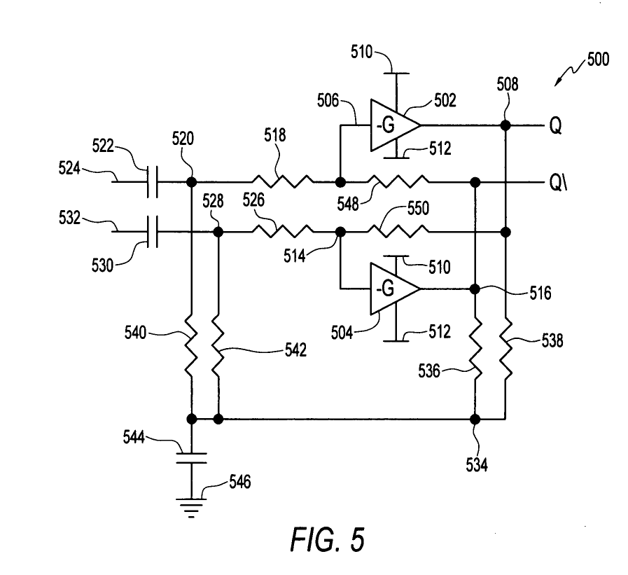

FIG. 5 shows, in electrical schematic diagram form, a receiver device 500 according to one embodiment of the invention: The receiver device 500 includes a first negative gain (inverting) amplifier 502 and a second inverting amplifier 504. Amplifier 502 includes a signal input coupled to a first node 506, a signal output coupled to a second node 508, a first power input coupled to a first, e.g., positive, source of supply voltage 510 and a further power input coupled to a second, e.g., negative, source of supply voltage 512.

Amplifier 504 includes a further signal input coupled to a further node 514, a further signal output coupled to a further node 516, a further power input coupled to the first, i.e., positive, source of supply voltage 510 and a further power input coupled to the second, i.e., negative, source of supply voltage 512. Node 506 is coupled through a first resistor 518 to a further node 520. Node 520 is coupled through a first capacitor 522 to a first input 524 of the receiver device 500. Node 514 is coupled through a further resistor 526 to a further node 528. Node 528 is coupled through a further capacitor 530 to a second input 532 of the receiver device 500.

A further node 534 is mutually coupled to further resistors 536 and 538, and through resistors 536 and 538 to nodes 516 and 508 respectively. Node 534 is also mutually coupled to resistors 540 and 542, and through resistors 540 and 542 to nodes 520 and 528 respectively. In addition, node 534 is coupled through a further capacitor 544 to a source of ground potential 546.

Node 516 is coupled through a further resistor 548 to node 506. Node 508 is coupled through resistor 550 to node 514. Accordingly, resistors 548 and 550 serve as feedback paths between the output of amplifier device 504 and the input of amplifier device 502 and the output of amplifier device 502 and the input of amplifier device 504 respectively. Also, it should be noted that nodes 508 and 516 serve as respective noninverting and inverting output nodes of the receiver device 500.

In operation, the receiver device 500 of FIG. 5 is bi-stable in much the same fashion as the flip-flop device 300 of FIG. 3. Assume, for example, that resistor 536 has a resistance value equal to that of resistor 538. Assume also that amplifier 502 has a logic one output state while amplifier 504 has a logic zero output state. The logic one output state of amplifier 502 is substantially equal to the voltage of the source of positive supply voltage 510. The logic 0 output state of amplifier 504 is substantially equal to the voltage of the source of negative supply voltage 512. Resistors 536 and 538 act as a voltage divider such that node 534 is driven to a voltage half way between the source of positive supply voltage 510 and the source of negative supply voltage 512. This voltage constitutes a reference voltage for the system and is maintained by the amplifiers 502, 504 halfway between the positive supply voltage 510 and the negative supply voltage 512.

When an input at nodes 524 and 532 is substantially null, as during a data gap, a voltage of node 506 is determined by the voltage divider including resistors 548, 518 and 540 coupled in series between nodes 516 and 534. Assuming that the sum of the resistances of resistors 518 and 540 is sufficiently greater than the resistance of resistor 548, and that node 516 is substantially at the negative supply voltage 512, node 506 is maintained well below the reference voltage on node 534 (i.e. in a logic zero state).

Correspondingly, while the input at nodes 524 and 532 is null, a voltage at node 514 is determined by the voltage divider including resistors 550, 526 and 542 coupled in series between nodes 508 and 534. Assuming that the sum of the resistances of resistors 526 and 542 is sufficiently greater than the resistance of resistor 550, and that node 508 is substantially at the positive supply voltage 510, node 514 is maintained well above the reference voltage on node 534 (i.e. in a logic one state).

One of skill in the art will appreciate that had a previous data burst ended with node 508 in a logic zero state and node 516 and a logic one state, complementary logic states would be maintained throughout the device 500, but the device state would be equally stable.

When a data burst is received, nodes 524 and 532 assume, for example, logic one and logic zero voltages respectively. One of skill in the art will appreciate that by selecting the resistance ratio of resistors 518 and 548 and of resistors 526 and 550 appropriately, these incoming voltages can force nodes 506 and 514 to transition to complementary logic values.

For example, node 520 can be forced by the incoming signal to a voltage value close to the positive supply voltage 510. Assuming that the resistance of resistor 518 is substantially less than that of resistor 548 node 506 is driven to a logic high value, causing the output of amplifier 502 to toggle. Concurrently, node 528 can be driven by the incoming signal to a voltage value close to the negative supply voltage 512.

Again, assuming that the resistance of resistor 526 is substantially less than that of resistor 550, node 514 is driven to a logic low value, causing the output of amplifier 504 to toggle. One of skill in the art will readily appreciate that by appropriate selection of the resistance values of the illustrated resistors, the receiver device 500 may be designed to respond to incoming data signals while rejecting spurious low-level noise and avoiding unwanted chatter.

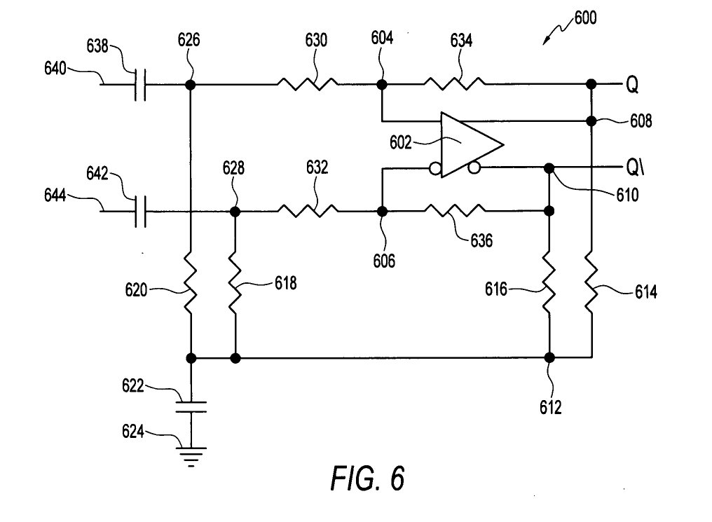

FIG. 6 shows, in electrical schematic diagram form, a receiving device 600 according to another embodiment of the invention. The receiving device 600 includes an amplifier device 602. The amplifier device 602 has a noninverting input coupled to a first node 604 and an inverting input coupled to a further node 606. The amplifier device 602 also has a noninverting output coupled to a further node 608 and an inverting output coupled to a still further node 610. A reference node 612 is mutually coupled to a first resistor 614, a second resistor 616, a third resistor 618, and a fourth resistor 620. The reference node 612 is also coupled through a capacitor device 622 to a source of ground potential 624. Reference node 612 is coupled through resistor 614 to node 608 and through resistor 616 to node 610. Reference node 612 is also coupled through resistor 620 to a further node 626 and through resistor 618 to a further node 628.

A fifth resistor 630 is coupled between nodes 626 and 604. A sixth resistor 632 is coupled between nodes 628 and 606. A seventh resistor 634 is coupled between nodes 604 and 608 and an eighth resistor 636 is coupled between nodes 606 and 610.

Node 626 is coupled through a further capacitive device 638 to a noninverting input node 640 of receiving device 600. Note 628 is coupled through still a further capacitive device 642 to an inverting input node 644 of receiving device 600. According to the illustrated configuration of receiver device 600, node 608 constitutes a noninverting output node (Q) and node 610 constitutes an inverting output (Q\) of the receiver device.

One of skill in the art will appreciate that the receiver device 600 of FIG. 6 is similar in its biasing network to the receiver device 500 of FIG. 5. Accordingly, receiver device 600 has a single differential input/differential output amplifier device 602, in contrast to the two single ended input/output amplifiers 502, 504 of receiver device 500. Nevertheless, one sees that series connected resistors 634, 630 and 620 of receiver device 600 function similarly to series connected resistors 548, 518 and 540 of receiver device 500. Likewise, series connected resistors 636, 632 and 618 of receiver device 600 function similarly to resistors 550, 526 and 542 of receiver device 500.

We assume, for example, that resistor 614 has a resistance value substantially equal to that of resistor 616 and that, in steady-state, the inverting and noninverting outputs of amplifier 602 are substantially at respective supply rail voltages. Under such circumstances, node 612 serves as a reference voltage node that is maintained at a voltage substantially halfway between the two supply rail voltages.

During a data gap time interval, and assuming appropriate selection of resistor values, when input nodes 640 and 644 are at null potential the voltage divider consisting of resistor 620 and resistor 630 in series with resistor 634 maintains node 604 in status quo at a voltage near the rail voltage present on node 608. In like fashion, the voltage divider consisting of resistor 618 and resistor 632 in series with resistor 636 maintains node 606 in status quo at a voltage near the rail voltage present on node 610. In effect, resistors 634 and 636 provide positive feedback to nodes 604 and 606 respectively. As such, the amplifier 602 is stable and insensitive low amplitude noise present across input nodes 640 and 644.

Nevertheless, when signal level voltages are received across input nodes 640 and 644, nodes 626 and 628 are driven to respective voltages sufficient to raise nodes 604 and 606 respectively and toggle the state of amplifier 602.

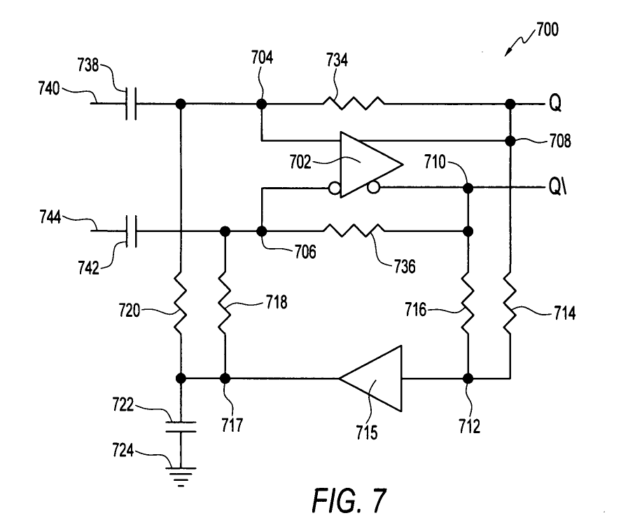

FIG. 7 shows, in electrical schematic diagram form, a receiving device 700 according to another embodiment of the invention. The receiving device 700 includes a fully differential amplifier 702. Amplifier 702 has a noninverting input coupled to a first node 704 and an inverting input coupled to a further node 706. Amplifier 702 also has a noninverting output coupled to a further node 708 and an inverting output coupled to another node 710. A reference node 712 is mutually coupled to a first resistor 714, a second resistor 716, and an input of a single ended buffer amplifier 715. An output of the buffer amplifier is mutually coupled, at a further node 717, to two further resistors 718, 720. Node 717 is also coupled through a capacitor device 722 to a source of ground potential 724. Node 712 is coupled through resistor 714 to node 708 and through resistor 716 to node 710. Reference node 717 is coupled through resistor 720 to node 704 and through resistor 718 to node 706.

A further resistor 734 is coupled between nodes 704 and 708 and another resistor 736 is coupled between nodes 706 and 710. Node 704 is coupled through a first capacitive device 738 to a noninverting input node 740 of receiver device 700. Node 706 is coupled through a second capacitive device 742 to an inverting input node 744 of the receiver device 700. Node 708 constitutes a noninverting output node (Q) of receiver device 700 and node 710 constitutes an inverting output node (Q\) of the receiver device.

One of skill in the art will appreciate that resistors 734 and 736 of receiver device 700 provide respective positive feedback paths from output node 708 to input node 704 and from output node 710 to input node 706. Accordingly, fully differential amplifier 702 exhibits a set-reset flip-flop operating characteristic similar to that presented in the logic table of FIG. 4.

Assuming that resistors 714 and 716 have substantially equal resistive values, and that the inverting and noninverting outputs of amplifier 702 reside, when in steady-state, substantially at respective supply rail voltages, node 712 is adapted to exhibit a reference voltage that is substantially halfway between the supply rail voltages.

In one embodiment of the invention, buffer amplifier 715 is a unity gain voltage amplifier that is adapted to provide a voltage at its output that is substantially equal to a voltage received at its input. Typically, such an amplifier has an output impedance that is significantly lower than its input impedance. Accordingly, amplifier 715 is adapted to drive node 717 to a bias voltage equal to the reference voltage found that node 712 even in the face of substantial loading at, for example, nodes 704 at 706.

One of skill in the art will appreciate that the instantaneous voltage at node 704 is given by the equation:

$${V}_{704} = \frac{( {V}_{708} - {V}_{717} ) {R}_{720}}{( {R}_{720} + {R}_{734} )} + {V}_{717}$$

Where V₇₀₈ is the voltage at node 708;
V₇₁₇ is the voltage at node 717;
R₇₂₀ is the resistance value of resistor 720; and
R₇₃₄ is the resistance value of resistor 734.

The instantaneous voltage at node 706 is given by the equation:

$${V}_{706} = \frac{( {V}_{710} - {V}_{717} ) {R}_{718}}{( {R}_{718} + {R}_{736} )} + {V}_{717}$$

where V₇₁₇ is defined as indicated above, and
Where V₇₁₀ is the voltage at node 710;
R ₇₁₈ is the resistance value of resistor 718;
R ₇₃₆ is the resistance value of resistor 736.

The magnitude of the differential signal between the nodes 704 and 706 must be greater than a threshold voltage V_{D} in order to force the receiver device 702 alter its output state. This threshold voltage V_{D} is given by the equation:

$${V}_{D} = \frac{( {V}_{708} - {V}_{710} )}{( {R}_{F} + {R}_{I} )} \times {R}_{I}$$

where R₇₃₄=R₇₃₆=RF; and
where R_{720 =R}_{718 =R}ₗ.

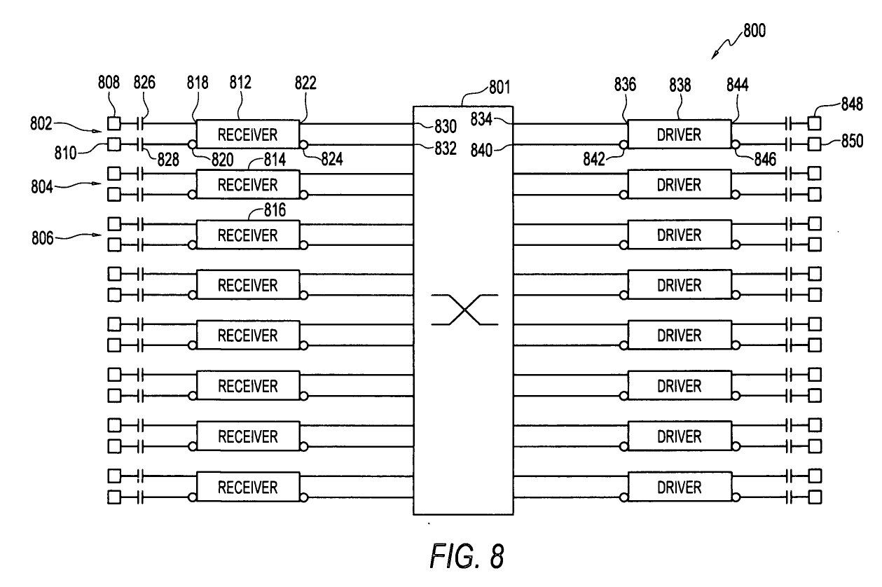

FIG. 8 shows, in block diagram form, an exemplary data communication device 800 according to one embodiment of the invention. As illustrated, the data communication device 800 includes a crossbar switch device 801 adapted to switch a plurality of data signals. One of skill in the art will appreciate, however, that a wide variety of other switching and data handling devices may be used in various embodiments of the invention.

As shown, the data communication device 800 includes a plurality of differential input ports 802, 804, 806, etc. Each of the differential input ports includes a respective noninverting input node and a respective inverting input node. For example, input port 802 includes noninverting input node 808 and inverting input node 810.

According to the illustrated embodiment, the data communication device 800 further includes a plurality of bi-stable (flip-flop) receiver devices, e.g. 812, 814, 816, etc. In one embodiment of the invention bi-stable receiver device 812 utilizes positive feedback to maintain a stable output during a data gap time interval.

The exemplary bi-stable receiver device 812 includes a noninverting input 818, an inverting input 820, a noninverting output 822 and an inverting output 824. In the exemplary embodiment, noninverting input 818 is coupled through a capacitor 826 to noninverting input node 808. Inverting input 820 is coupled through a further capacitor 828 to inverting input node 810. Accordingly, the bi-stable receiver device 812 is AC coupled to input port 802.

The outputs of bi-stable receiver device 812, however, are DC coupled to respective inputs of the crossbar switch device 801. Accordingly, crossbar switch device 801 includes a first input 830 directly connected to noninverting output 822 and a second input 832 directly connected to inverting output 824.

In like fashion, a first output 834 of crossbar switch device 801 is directly coupled to a noninverting input 836 of an output driver device 838. A second output 840 of crossbar switch device 801 is directly coupled to an inverting input 842 of output driver device 838. Accordingly, in one embodiment of the invention, a plurality of DC coupled connections are disposed within the data communication device 800.

In the exemplary embodiment, however, AC coupling is used once again to couple the outputs 844, 846 to respective output nodes 848, 850 of the data communication device 800. One of skill in the art will appreciate that a wide variety of configurations are possible including AC coupled and DC coupled interfaces within exemplary embodiments of the invention. The inventor notes that AC coupling in the prior art is used not only at the inputs to the receiver devices, but also at the interfaces between receivers and subsequent data network switching devices. According to the present invention, in order to avoid generating chatter in any interface in a data path within the switch gear, DC coupling is employed in various embodiments throughout the data communication device.

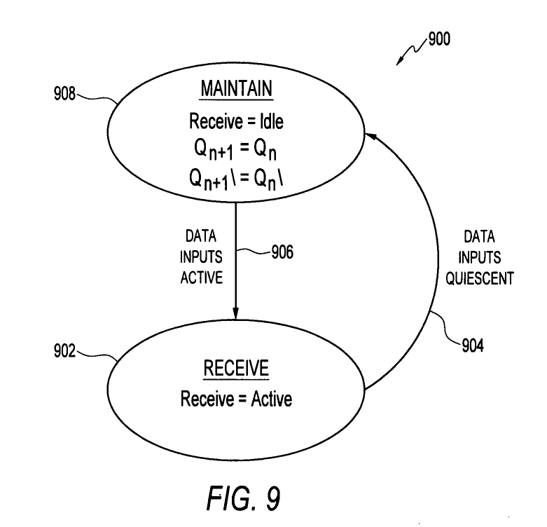

FIG. 9 shows, in state diagram form, an operation 900 of a bi-stable receiver device according to one embodiment of the invention. During a first exemplary state 902, the receiver device is receiving a data burst, and consequently experiencing regular data transitions at an input port. While in state 902, the outputs of the bi-stable receiver device are regularly changing state. Thereafter, at some time, the received data burst ends and the bi-stable receiver device makes a state transition 904 to a data gap state 906. While in data gap state 906, the outputs of the bi-stable receiver device, are maintained in a constant state by, for example, positive feedback within the bi-stable receiver device.

The data gap endures for some time interval, after which, a new data burst is received. Upon receiving the new data burst, the bi-stable receiver device makes a further state transition 906 back to receiving state 902.As will be evident to the reader, in various embodiments the above-described succession of state transitions can be repeated indefinitely while the bi-stable receiver device is in service.

While exemplified embodiments of the invention have been described and illustrated above, it should be understood that these are exemplary of the invention and are not to be considered as limiting. Accordingly, the invention is not to be considered as limited by the foregoing description, but is only limited by the scope of the claims appended hereto.

1. A digital data receiving device comprising:
an amplifier; and
a positive feedback device coupled to said amplifier.

2. A digital data receiving device as defined in claim 1 wherein said positive feedback device is adapted to maintain an output of said amplifier in a steady-state during a quiescent signal time interval.

3. A digital data receiving device as defined in claim 1 wherein said positive feedback device is adapted to prevent a transition of an output state of said amplifier in response to a sub-threshold input signal.

4. A digital data receiving device as defined in claim 1 wherein an output of said digital data receiving device is adapted to be DC coupled to at least one of an input of a digital data router and an output of a digital data switch.

5. A data receiver comprising:
a fully differential amplifier, said fully differential amplifier having at least one inverting input node, at least one noninverting input node, at least one inverting output node and at least one noninverting output node;
a resistive device, said resistive device being adapted to be coupled between said inverting input and output nodes.

6. A data receiver as defined in claim 5 further comprising a positive feedback device, said positive feedback device being adapted to maintain a steady-state between said inverting and noninverting output nodes in the absence of a super-threshold signal applied between said inverting and noninverting input nodes.

7. A data receiver as defined in claim 5 wherein said data receiver is adapted to exhibit a set-reset flip-flop response characteristic.

8. A data receiver as defined in claim 6 wherein said data receiver is adapted to respond to a received super-threshold data signal and ignore a received sub-threshold threshold noise signal.

9. A data receiver as defined in claim 5 wherein said respective input nodes are have an impedance adapted to be coupled to a transmission line.

10. A data receiver as defined in claim 5 wherein a resistive value of said resistive device is related to a response threshold value of said data receiver.

11. A data switching system comprising:
a switching matrix;
an input receiver; and
at least one output transmitter, wherein a data path between said input receiver, said switching matrix and said output transmitter includes an exclusively DC coupled data path.

12. A pluggable line interface unit comprising a data port, said data port being adapted to DC couple said pluggable line interface unit at least one of a data switching device and a data routing device.

13. A pluggable line interface unit as defined in claim 12 further comprising a set-reset flip-flop circuit.

14. A data switching system comprising:
a switching matrix;
at least one plug compatible data port, said plug compatible data port being adapted to receive a pluggable line interface whom device, wherein a data path interface between said plug compatible data port and said pluggable line interface device includes at least one exclusively DC coupled data path.

15. A method of receiving data comprising:
receiving a valid data transition signal at an input port;
setting a receiving system state responsive to said received valid data transition signal;
receiving a plurality of invalid signal transitions at said input port; and
rejecting said plurality of invalid signal transitions to maintain a stable receiving system state responsive to receiving a positive feedback signal.
